(19) United States
(12) Patent Application Publication
(10) Pub. No.: US 2006/0117565 A1
(43) Pub. Date: Jun. 8, 2006

(54) Shrinking apparatus for a heat pipe and method for the same

(76) Inventor: Jia-Hao Li, Kao Hsiung Hsien (TW)

Correspondence Address: HDSL, 4331 STEVENS BATTLE LANE, FAIRFAX, VA, 22033, US

(21) Appl. No.: 11/000,960

(22) Filed: Dec. 2, 2004

(51) Int. Cl. B23P 6/00; B23P 15/26

(52) U.S. Cl. 29/890.032; 29/726; 29/727

(57) ABSTRACT

A method for shrinking a heat pipe and a shrinking apparatus for a heat pipe are disclosed. A composite die is provided with a plurality of die blocks. The heat pipe to be shrunk is placed into a die cavity within the composite die. An arbor unit is placed into the heat pipe. The heat pipe is struck by the composite die while the arbor unit upholds a wick structure of the heat pipe against a wall of the heat pipe. The arbor unit is extracted from the heat pipe after the heat pipe is shrunk. The method for shrinking a heat pipe ensures a through heat pipe after swage process.

### BACKGROUND OF THE INVENTION

1. Field of the Invention

The present invention relates to a shrinking apparatus for a heat pipe and method for the same, especially to a shrinking apparatus for a heat pipe under swage process and method for the same.

2. Description of Prior Art

The pipe shrinkage process for a heat pipe is generally performed by swage tooling. As shown in FIG. 1, the conventional processing tool 1a comprises a plurality of rotators 10a in ring arrangement. The conventional processing tool 1a comprises a punching die 11a and a skirt 12a placed in the spindle thereof, which are surrounded by the rotators 10a. The punching die 11a is rotated with the spindle of the processing tool 1a such that the rotators 10a render the skirt 12a with upward and downward movement in predetermined stroke. Therefore, the end of the heat pipe to be subjected to pipe shrinkage process is inserted to a die cavity of the punching die 11a and punched by the punching die 11a for shrinking the end of the heat pipe.

However, as shown in FIG. 2, when the pipe body 2a of the heat pipe is shrunk by the die cavity 110a of the punching die 11a, the wick structure of the pipe body 2a tends to be of corrugated shape and pile at end of the pipe body 2a due to the size shrinkage. The working fluid is hard to fill into the pipe body 2a at next stage.

### SUMMARY OF THE INVENTION

The present invention is to provide a shrinking apparatus for a heat pipe under the swage process and method for the same. The heat pipe has through pipe shape after the swage process, and the wick structure thereof will not be accumulated on inlet of the heat pipe. Therefore, the shrinking apparatus facilitates the post treatment of the heat pipe.

Accordingly, the present invention provides a method for shrinking a heat pipe. A composite die is provided with a plurality of die blocks. The heat pipe to be shrunk is placed into a die cavity within the composite die. An arbor unit is placed into the heat pipe. The heat pipe is struck by the composite die while the arbor unit upholds a wick structure of the heat pipe against a wall of the heat pipe. The arbor unit is extracted from the heat pipe after the heat pipe is shrunk. The method for shrinking a heat pipe ensures a through heat pipe after swage process.

Furthermore, the present invention provides a shrinking apparatus for a heat pipe. The shrinking apparatus comprises a composite die with a plurality of die blocks, the plurality of die blocks being assembled to define a die cavity therein, the die cavity having an inlet and a shrinking region inner to the inlet and having a smaller diameter than the inlet. The shrinking apparatus further comprises an arbor unit placed in the die cavity. One end of the arbor unit is suspended in the die cavity. The arbor unit upholds a wick structure of the heat pipe against a wall of the heat pipe, thus preventing obstacle from accumulating on the inlet.

### BRIEF DESCRIPTION OF DRAWING

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 shows the operation of a prior art processing tool.

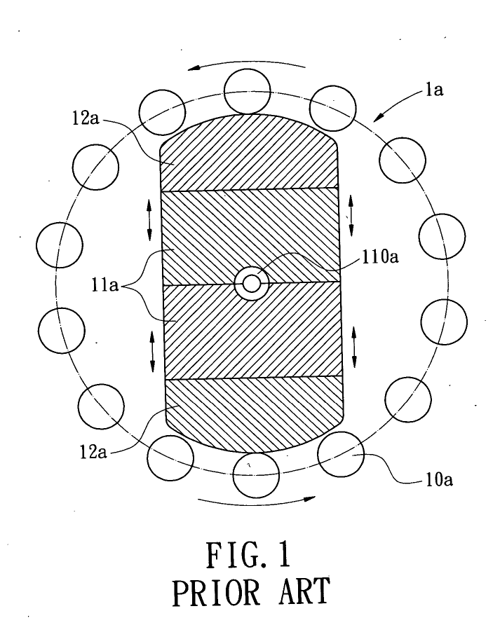

FIG. 2 shows a prior art swage process for the heat pipe.

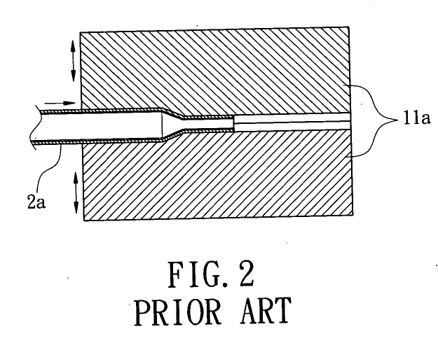

FIG. 3 shows an exploded view of the first preferred embodiment according to the present invention.

FIG. 4 shows a sectional view of the first preferred embodiment according to the present invention.

FIG. 5 is a schematic view showing operation of the first preferred embodiment according to the present invention.

FIG. 6 is another schematic view showing operation of the first preferred embodiment according to the present invention.

FIG. 7 is an enlarged view of part A in FIG. 6.

FIG. 8 is a sectional view showing the supporting stage of the first preferred embodiment being assembled to the composite die.

FIG. 9 shows a sectional view of the second preferred embodiment according to the present invention.

FIG. 10 is an exploded view showing the supporting stage of the first preferred embodiment being provided with dust-releasing grooves.

### DETAILED DESCRIPTION OF THE INVENTION

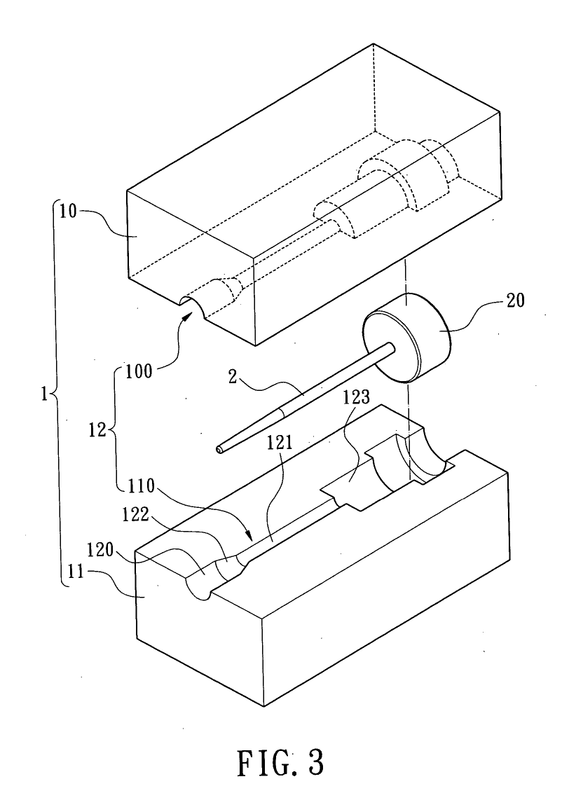

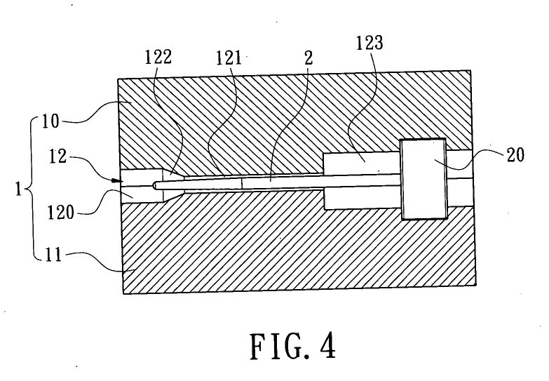

Please refer to FIG. 3 and FIG. 4. according to the first preferred embodiment of the present invention. The present invention provides a pipe shrinking apparatus for the heat pipe and method for the same, wherein the pipe shrinking apparatus uses the swage process to shrink the hear pipe. The pipe shrinking apparatus for the heat pipe according to the present invention comprises composite die 1 and an arbor unit 2.

The composite die 1 comprises die blocks 10, 11. More particularly, in the preferred embodiment of the present invention, the first and second die blocks 10, 11 are stacked together to form a die cavity 12 therein. The die cavity 12 comprises an upper cavity 100 defined on bottom of the first die block 10, and a lower cavity 110 defined on top of the second die block 11. The upper cavity 100 and the lower cavity 110 together form the die cavity 12 when the first die block 10 is superimposed on the top of the second die block 11. The arbor unit 2 can be received by the die cavity 12.

The die cavity 12 comprises an inlet 120 and a shrinking region 121 having smaller diameter. One end of the arbor unit 2 is inserted into the shrinking region 121. In the preferred embodiment, the inlet 120 and the shrinking region 121 are bridged by a tapered region 122 with a tapered diameter. A dust storage region 123 is defined at a rear end of the shrinking region 121 and communicated with the shrinking region 121.

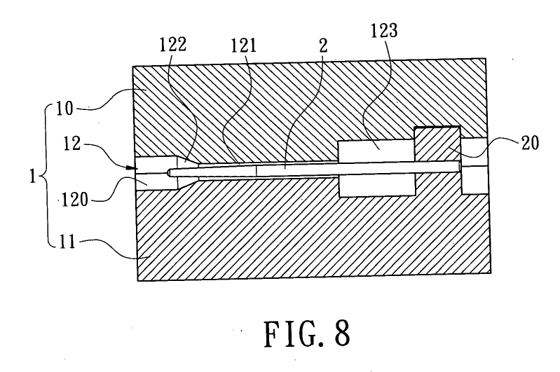

Moreover, in the preferred embodiment of the present invention, the arbor unit 2 has one end inserted into the shrinking region 121, and another end connected to a supporting stage 20. The supporting stage 20 is clamped into the die cavity 12 by the first die block 10 and the second die block 11. Therefore, the arbor unit 2 has one end inserted into and suspending in the shrinking region 121. Moreover, as shown in FIG. 8, the supporting stage 20 can be assembled to one of the first die block 10 and the second die block 11. Moreover, the suspending end of the arbor unit 2 can be of cone shape.

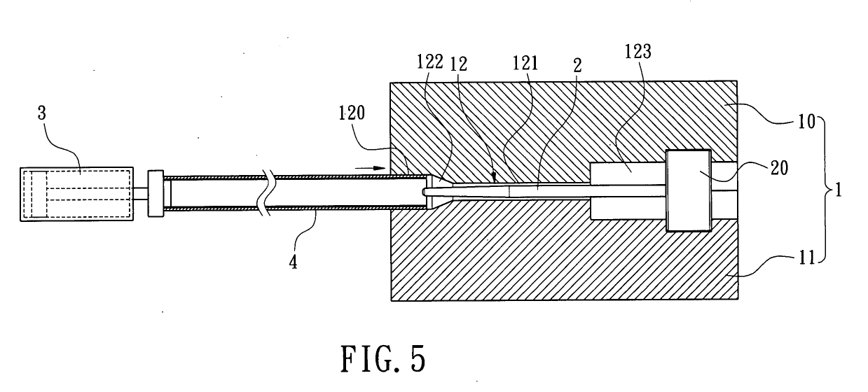

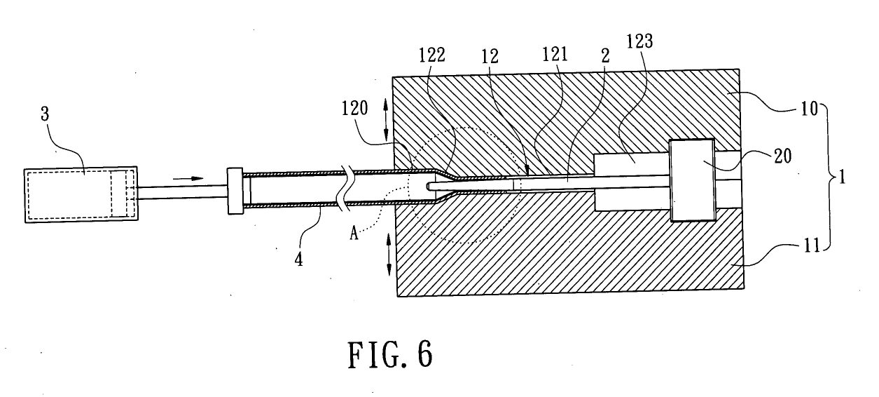

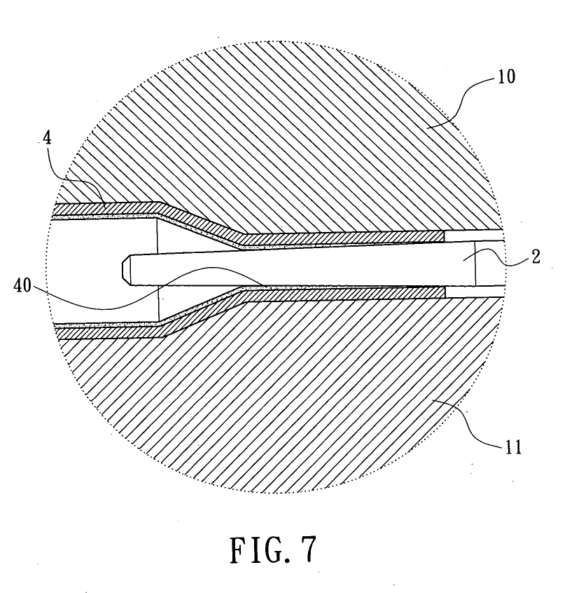

With reference to FIGS. 5 and 6, the end of the heat pipe 4, which is to be processed, is inserted gradually into the inlet 120 of the die cavity 12. More particularly, the heat pipe 4 is pushed by a pushing unit 3 opposite to the composite die 1. In the preferred embodiment of the present invention, the pushing unit 3 can be pneumatic pressure cylinder or oil pressure cylinder. The first die block 10 and the second die block 11 are moved upward and downward to strike the heat pipe 4 such that the heat pipe 4 can fit the shape of the shrinking region 121, thus performing pipe shrinking process. Meanwhile, as shown in FIG. 7, the arbor unit 2 upholds the wick structure 40 against the wall of the heat pipe 4, thus preventing piling and accumulation of the wick structure 40. Moreover, the arbor unit 2 facilitates the die-releasing operation of the heat pipe 4 because the end of the arbor unit 2 in the shrinking region 121 has conic shape.

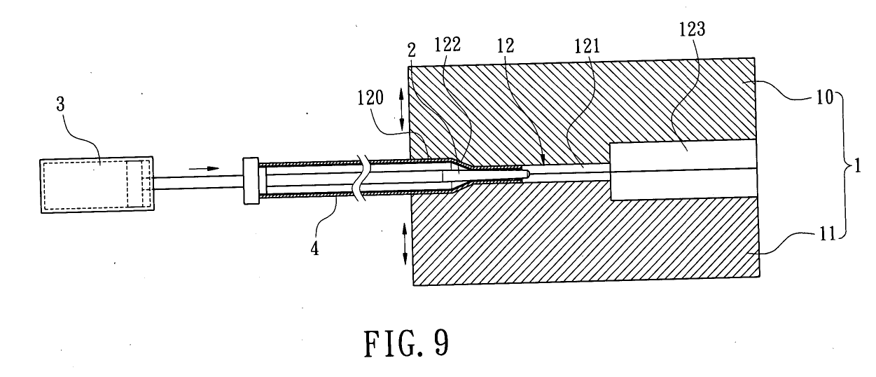

Moreover, FIG. 9 shows the second preferred embodiment of the present invention. The arbor unit 2 is initially placed into the heat pipe 4 and pushed together by the pushing unit 3 into the die cavity 12. Therefore, the arbor unit 2 upholds the wick structure 40 against the wall of the heat pipe 4 until desired shape of the heat pipe 4 is formed. Afterward, the heat pipe 4 is retreated from the die cavity 12 and the arbor unit 2 is removed from the heat pipe 4 to form a through heat pipe 4.

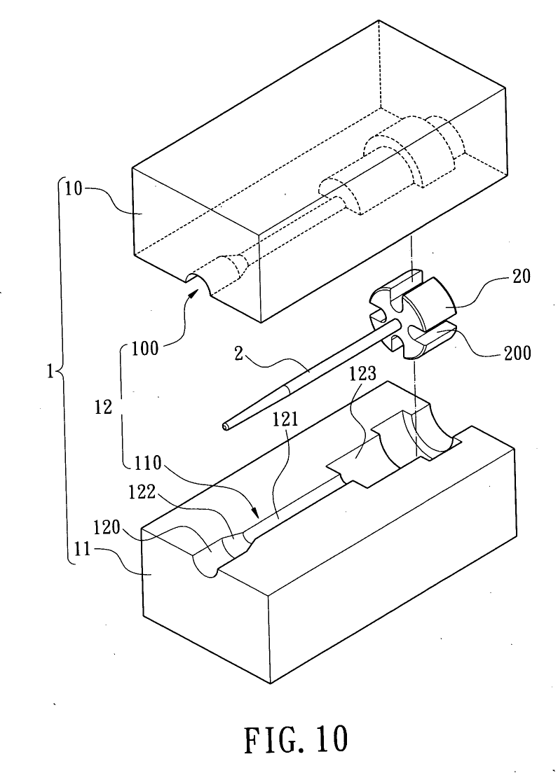

As shown in FIG. 10, the dust storage region 123 is defined after the shrinking region 121 to receive dust produced during the first die block 10 and the second die block 11 striking the heat pipe 4. Moreover, dust-releasing grooves 200 are defined on the supporting stage 20 to drain the dust in the dust storage region 123.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. A method for shrinking a heat pipe, comprising following steps:
providing a composite die with a plurality of die blocks;
placing the heat pipe into a die cavity within the composite die;
placing an arbor unit into the heat pipe;
striking the heat pipe by the composite die while the arbor unit upholding a wick structure of the heat pipe against a wall of the heat pipe; and
extracting the arbor unit from the heat pipe after the heat pipe being shrunk.

2. A shrinking apparatus for a heat pipe, comprising
a composite die with a plurality of die blocks, the plurality of die blocks being assembled to define a die cavity therein; and
an arbor unit placed in the die cavity;
wherein the die cavity has an inlet and a shrinking region inner to the inlet, and one end of the arbor unit is suspended into the die cavity.

3. The shrinking apparatus for a heat pipe as in claim 2, wherein the composite die comprises a first die block stacked on a second die block.

4. The shrinking apparatus for a heat pipe as in claim 3, wherein the die cavity comprises an upper cavity defined on bottom of the first die block, and a lower cavity defined on top of the second die block.

5. The shrinking apparatus for a heat pipe as in claim 2, wherein the inlet and the shrinking region are bridged by a tapered region with a tapered diameter.

6. The shrinking apparatus for a heat pipe as in claim 2, wherein a dust storage region is defined at a rear end of the shrinking region and communicated with the shrinking region.

7. The shrinking apparatus for a heat pipe as in claim 2, further comprising a supporting stage connected to the arbor unit, the supporting stage being clamped into the die cavity by the first die block and the second die block.

8. The shrinking apparatus for a heat pipe as in claim 7, wherein the supporting stage comprises a plurality of dust-releasing grooves defined thereon.

9. The shrinking apparatus for a heat pipe as in claim 2, further comprising a supporting stage connected to the arbor unit, the supporting stage being assembled to one of the first die block and the second die block.

10. The shrinking apparatus for a heat pipe as in claim 9, wherein the supporting stage comprises a plurality of dust-releasing grooves defined thereon.

11. The shrinking apparatus for a heat pipe as in claim 2, wherein the one end of the arbor unit suspended into the die cavity is a conic end.

12. A shrinking apparatus for a heat pipe, comprising
a composite die with a plurality of die blocks, the plurality of die blocks being assembled to define a die cavity therein, the die cavity having an inlet and a shrinking region inner to the inlet and having a smaller diameter than the inlet;
an arbor unit placed in the die cavity; and
a pushing unit opposite the composite die and outside the die cavity, the pushing unit pushing the heat pipe into the die cavity.

13. The shrinking apparatus for a heat pipe as in claim 12, wherein the composite die comprises a first die block stacked on a second die block.

14. The shrinking apparatus for a heat pipe as in claim 13, wherein the die cavity comprises an upper cavity defined on bottom of the first die block, and a lower cavity defined on top of the second die block.

15. The shrinking apparatus for a heat pipe as in claim 12, wherein the inlet and the shrinking region are bridged by a tapered region with a tapered diameter.

16. The shrinking apparatus for a heat pipe as in claim 12, wherein a dust storage region is defined at a rear end of the shrinking region and communicated with the shrinking region.

17. The shrinking apparatus for a heat pipe as in claim 12, wherein one end of the arbor unit is suspended into the die cavity and is a conic end.

18. The shrinking apparatus for a heat pipe as in claim 12, wherein the pushing unit is a pneumatic pressure cylinder.

19. The shrinking apparatus for a heat pipe as in claim 12, wherein the pushing unit is an oil pressure cylinder.
